(19) United States
(12) Patent Application Publication
(10) Pub. No.: US 2009/0038636 A1
(43) Pub. Date: Feb. 12, 2009

(54) Cleaning method

(75) Inventors: Sander Frederik Wuister, Eindhoven (NL); Vadim Yevgenyevich Banine, Helmond (NL); Maarten Marinus Johannes Van Herpen, Heesch (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/889,213

(22) Filed: Aug. 9, 2007

(51) Int. Cl. B08B 5/00; B08B 3/00

(52) U.S. Cl. 134/1; 134/19; 134/201; 134/42

(57) ABSTRACT

A method of cleaning an imprint template is disclosed. The method includes exposing the imprint template to a reductive fluid.

### FIELD

The present invention relates to a cleaning method, e.g. a method of cleaning a template for use in imprint lithography.

### BACKGROUND

In lithography, there is an ongoing desire to reduce the size of features in a lithographic pattern to increase the density of features on a given substrate area. In photolithography, the push for smaller features has resulted in the development of technologies such as immersion lithography and extreme ultraviolet (EUV) lithography, which are however rather costly.

A potentially less costly road to smaller features that has gained increasing interest is so-called imprint lithography, which generally involves the use of a “stamp” to transfer a pattern onto a substrate. An advantage of imprint lithography is that the resolution of the features is not limited by, for example, the wavelength of a radiation source or the numerical aperture of a projection system as in photolithography, but mainly just by the pattern density on the stamp (also referred to as a template). For example, the template may have nanometer and/or micrometer features. There are three main approaches to imprint lithography, examples of which are schematically depicted in FIGS. 1a to 1c.

FIG. 1a shows an example of a type of imprint lithography that is often referred to as micro-contact printing. Micro-contact printing involves transferring a layer of molecules 11 (typically an ink such as a thiol) from a template 10 (for example a polydimethylsiloxane template) onto a resist layer 13 which is supported by a substrate 12 and planarization and transfer layer 12′. The template 10 has a pattern of features on its surface, the molecular layer being disposed upon the features. When the template is pressed against the resist layer, the layer of molecules 11 are transferred onto the resist. After removal of the template, the resist is etched such that the areas of the resist not covered by the transferred molecular layer are etched down to the substrate. For more information on micro-contact printing, see for example, U.S. Pat. No. 6,180,239.

FIG. 1b shows an example of so-called hot imprint lithography (or hot embossing). In a typical hot imprint process, a template 14 is imprinted into a thermosetting or a thermoplastic polymer resin 15 (or more generally an imprintable medium), which is on the surface of a substrate 12. The resin may for instance be spin coated and baked onto the substrate surface or, as in the example illustrated, onto a planarization and transfer layer 12′. When a thermosetting polymer resin is used, the resin is heated to a temperature such that, upon contact with the template, the resin is sufficiently flowable to flow into the pattern features defined on the template. The temperature of the resin is then increased to thermally cure (crosslink) the resin so that it solidifies and irreversibly adopts the desired pattern. The template may then be removed and the patterned resin cooled. In hot imprint lithography employing a layer of thermoplastic polymer resin, the thermoplastic resin is heated so that it is in a freely flowable state immediately prior to imprinting with the template. It may be necessary to heat a thermoplastic resin to a temperature considerably above the glass transition temperature of the resin. The template is pressed into the flowable resin and then cooled to below its glass transition temperature with the template in place to harden the pattern. Thereafter, the template is removed. The pattern will consist of the features in relief from a residual layer of the resin which residual layer may then be removed by an appropriate etch process to leave only the pattern features. Examples of thermoplastic polymer resins used in hot imprint lithography processes include poly (methyl methacrylate), polystyrene, poly (benzyl methacrylate) or poly (cyclohexyl methacrylate). For more information on hot imprint, see for example, U.S. Pat. Nos. 4,731,155 and 5,772,905.

FIG. 1c shows an example of ultraviolet (UV) imprint lithography, which involves the use of a transparent template and a UV-curable liquid as resist and imprintable medium (the term “UV” is used here for convenience but should be interpreted as including any suitable actinic radiation for curing the resist). A UV curable liquid is often less viscous than the thermosetting and thermoplastic resins used in hot imprint lithography and consequently may move much faster to fill template pattern features. A quartz template 16 is applied to a UV-curable resin 17 in a similar manner to the process of FIG. 1b. However, instead of using heat or temperature cycling as in hot imprint, the pattern is frozen by curing the resin with UV radiation that is applied through the quartz template onto the resin. After removal of the template, the resist is etched such that the areas of the resist not in relief are etched down to the substrate. A particular manner of patterning a substrate through UV imprint lithography is so-called step and flash imprint lithography (SFIL), which may be used to pattern a substrate in small steps in a similar manner to optical steppers conventionally used in IC manufacture. For more information on UV imprint, see for example, United States patent application publication US 2004-0124566, U.S. Pat. No. 6,334,960, PCT patent application publication WO 02/067055, and the article by J. Haisma entitled “Mold-assisted nanolithography: A process for reliable pattern replication”, J. Vac. Sci. Technol. B14(6), November/December 1996.

Combinations of the above imprint techniques are also possible. See, for example, United States patent application publication US 2005-0274693, which mentions a combination of heating and UV curing a resist.

### SUMMARY

As described above, an imprint template may be provided with a layer of molecules that are brought into contact with, for example, a layer of resist. Alternatively or additionally, the imprint template may be imprinted into an imprintable medium, for example a resin. When the molecules have been applied to the resist, or the imprint template has been imprinted into the imprintable medium, the imprint template is released from the resist and/or imprintable medium. It is possible that, during the release, molecules, resist or other material (for example imprintable medium) remains on the imprint template. The material which remains on the imprint template could be a thin layer, or could be particles of material or flakes of material or the like. If the material which remains on the imprint template after release is not removed, it may introduce an error into any subsequent patterns imprinted using the imprint template. This is because the material which remains on the imprint template may itself pattern, for example, the imprintable medium which it is brought into contact with during subsequent imprints. The introduced error could be so significant as to render the subsequent imprinted patterns defective, and even useless. A solution to this problem would be to replace an imprint template every time it becomes too contaminated to be used to imprint further patterns. However, this solution is undesirable due to the high costs associated with the fabrication of replacement imprint templates.

It is therefore desirable, for example, to provide a method of cleaning an imprint template, and an imprint template cleaning apparatus, which obviates or mitigates at least one of the disadvantages of the prior art, whether identified herein or elsewhere.

According to an aspect of the present invention, there is provided a method of cleaning an imprint template, comprising exposing the imprint template to a reductive fluid.

According to an aspect of the present invention, there is provided an imprint template cleaning apparatus, comprising a device which, in use, is arranged to expose an imprint template to a reductive fluid.

According to an aspect of the present invention, there is provided a method of cleaning a patterned surface, the patterned surface comprising one of glass, quartz or fused silica, the method comprising exposing the patterned surface to a reductive fluid.

According to an aspect of the present invention, there is provided a patterned surface cleaning apparatus comprising a device which, in use, is arranged to expose a patterned surface to a reductive fluid, wherein the patterned surface comprises one of glass, quartz or fused silica.

### BRIEF DESCRIPTION OF THE DRAWINGS

FIGS. 1a-c schematically show examples of, respectively, micro-contact printing, hot imprint, and UV imprint;

FIG. 2 schematically shows an imprint template having contamination attached to it;

FIG. 3 depicts an imprint lithography method according to an embodiment of the present invention;

FIG. 4 depicts an imprint lithography method according to an embodiment of the present invention;

FIGS. 5a and 5b depict imprint lithography methods according to an embodiment of the present invention;

FIGS. 6a and 6b schematically show the effects of one or more embodiments of the present invention; and

FIG. 7 schematically shows an imprint template after application of a method according to an embodiment of the present invention.

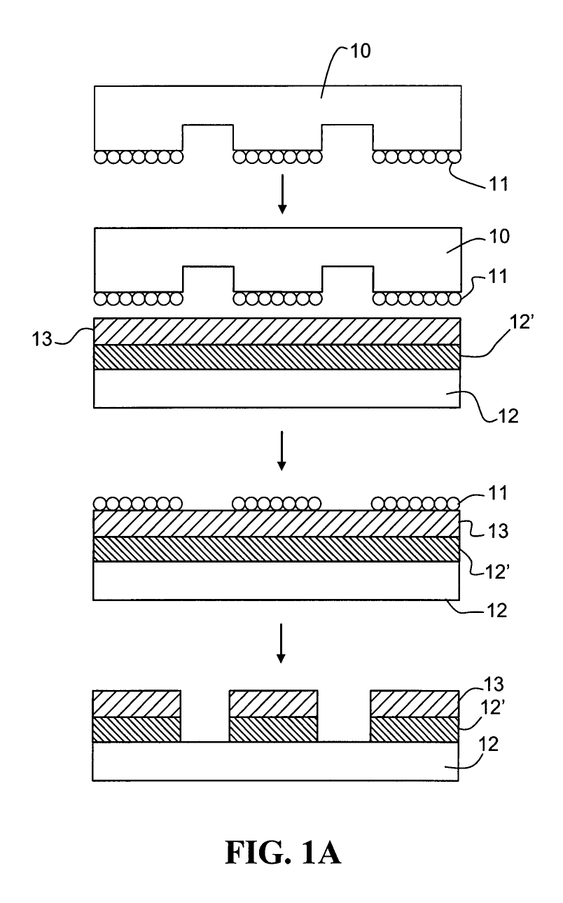

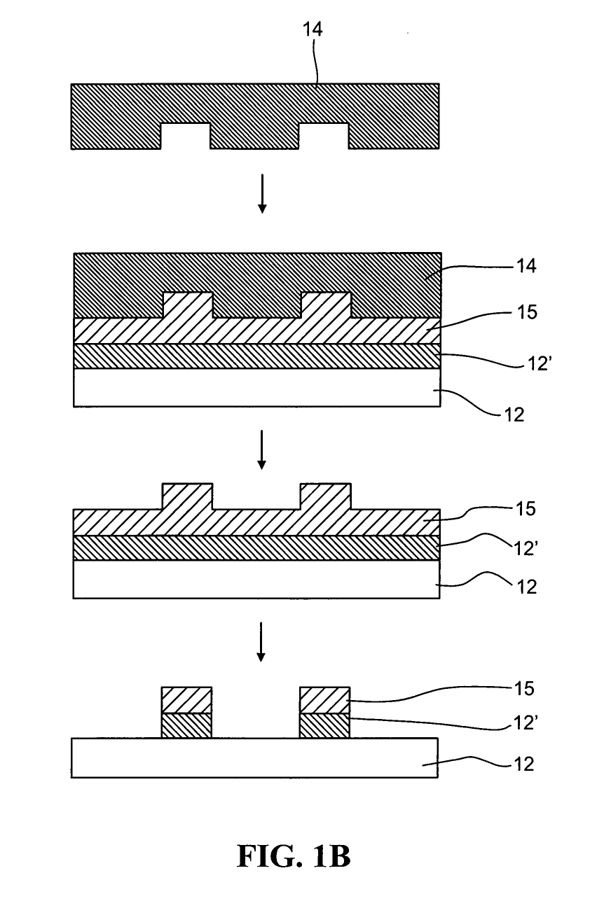

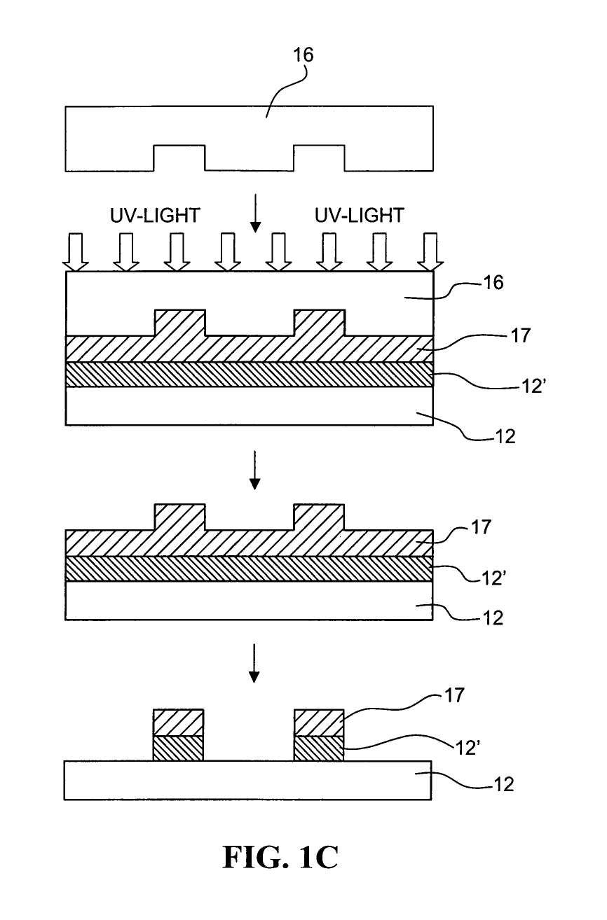

### DETAILED DESCRIPTION

According to an embodiment of the present invention, the imprint template is cleaned in a reductive environment. In other words, the imprint template is exposed to a reductive fluid, for example a reductive liquid or a reductive gas. In an example, resist or other material (for example, material containing organic matter) is removed from an imprint template using hydrogen radicals, its isotope deuterium, and/or combinations thereof.

Hydrogen radicals are produced in the dissociation of hydrogen molecules into atomic hydrogen radicals. This may be achieved in a number of ways, for example by passing hydrogen gas over a hot filament, or by introducing a microwave discharge or radio frequency (RF) discharge in the hydrogen gas. The reaction which takes place in the disassociation of hydrogen molecules into atomic hydrogen radicals is as follows: H₂(g)→2H.

The atomic hydrogen atoms react with, for example, resist, under the formation of methane (CH₄) from carbon, water (H₂O) from (organically bound) oxygen, and silane (SiH₄) from (organically bound) silicon. In an embodiment, all the reaction products are gaseous and will therefore not remain attached to, deposited on, etc. the imprint template. This results in cleaning of the imprint template. The imprint template may be formed from one or more materials which are substantially inert to the hydrogen radicals, or whichever reductive fluid is used to clean the imprint template. Suitable examples of materials which may be used to form the imprint template are glass, fused silica, and quartz.

An advantage of a method according to an embodiment of the present invention, and in particular the use of hydrogen radicals, is the speed of the cleaning process. A cleaning (or in other words etching) rate, though dependent on the exact conditions of the imprint template and contamination on the imprint template, is typically in the range of greater than 1 nm-2 nm per second. Applying this cleaning rate to a resist defect on the template with, for example, a depth of 50 nm results in a clean time of less than a minute. Furthermore, cleaning using a reductive fluid is gentler, and is less likely to damage the imprint template than, for example, a plasma.

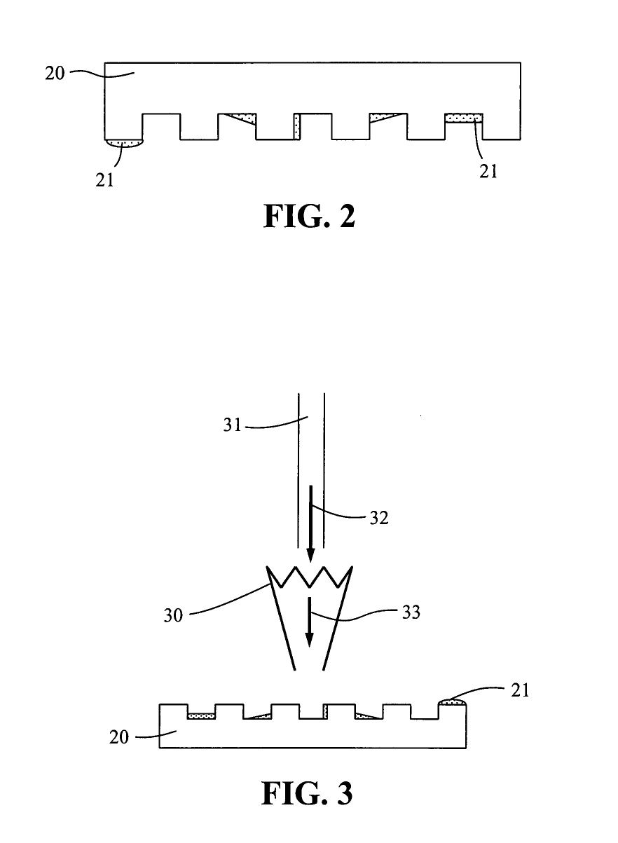

Implementation of a method according to an embodiment of the present invention will now be described with reference to FIGS. 2 to 6.

FIG. 2 depicts an imprint template 20. The imprint template 20 is formed from fused silica, but could be formed from any material which is relatively inert to a reductive fluid used to clean the imprint template. For example, the imprint template 20 may be formed from glass, fused silica, or quartz. The imprint template 20 has just been released from a layer of imprintable medium. It can be seen that after the release process, the imprint template 20 has some imprint medium 21 attached to it. As described above, it is desirable to remove the imprint medium 21 which has become stuck to the imprint template 20 in order to reduce or eliminate the possibility of introducing defects into later imprinted patterns.

FIG. 3 depicts an apparatus which may be used to clean the imprint template 20 of FIG. 2. FIG. 3 depicts a hot-filament 30 disposed adjacent to the surface of the imprint template 20 to be cleaned of imprint medium 21. In an embodiment, the hot-filament is made from tungsten, but can also be made from other materials such as Mo and Ni. A tube 31 is disposed adjacent to the hot-filament 30, and on the opposite side of the hot-filament 30 to the imprint template 20. The tube 31 is used to transport hydrogen 32 toward and over (and/or around, etc.) the hot-filament 30. It will be appreciated that the hydrogen may be transported using any suitable conduit, and not necessarily a tube.

In use, hydrogen 32 is passed through the tube 31 at a flow rate between 20 sccm and 300 sccm. The hydrogen 32 is passed over the hot-filament 30. The hot-filament 30 is maintained at a temperature of between 1750° C. and 2250° C. When the hydrogen 32 is passed over the hot-filament 30, it disassociates into atomic hydrogen radicals 33. The higher the temperature of the hot-filament 30, the higher the yield of hydrogen radicals 33 and thus the greater the etch (or cleaning) rate.

The cleaning of the imprint template 20 may be undertaken in any suitable environment, and maybe undertaken in an enclosed chamber (not shown). An optimum pressure within the chamber depends on the configuration of apparatus within the chamber. If there are no, for example metallic obstructions between the imprint template 20 and the hydrogen 32 emitted from the tube 31, a high pressure may be used, in order to limit wall recombination of hydrogen radicals 33. However, the pressure should not be too high as this may promote recombination of hydrogen radicals. A typical pressure along a path between the source of the hydrogen radicals 33 (e.g. around the hot-filament 30) and the imprint template 20 may be in the range of 0.1 to 20 kNm⁻².

As described above, all of the reaction products formed when using hydrogen radicals to clean the imprint template 20 may be, for example, gaseous, and evaporate away from the imprint template 20 leaving it with a clean surface.

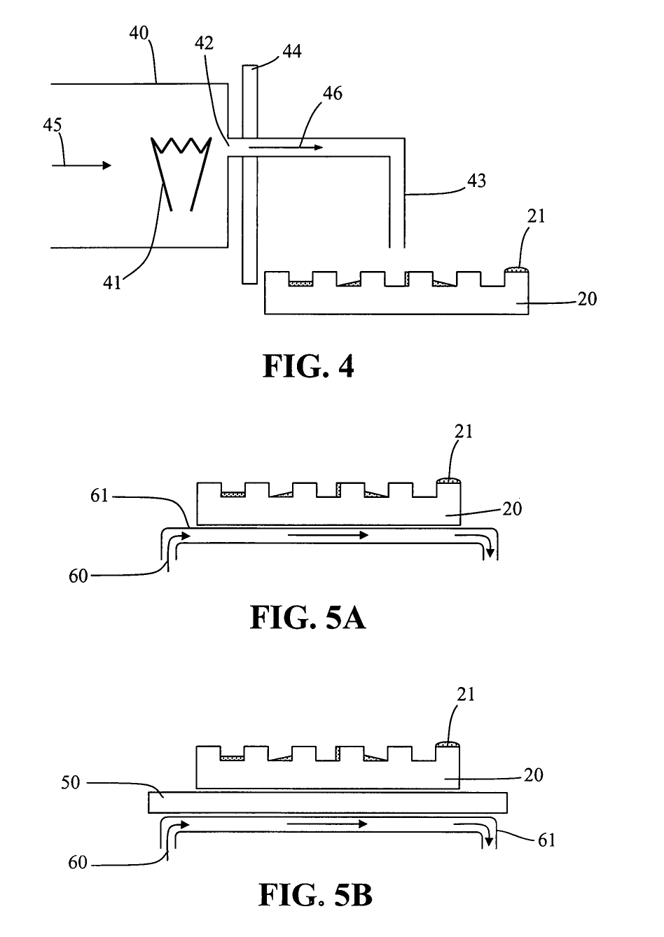

It is possible that the hot-filament 30 may heat the imprint template 20. Heating of the imprint template 20 is undesirable, since the heat may distort the imprint template 20 and any pattern with which it is provided. Therefore, it is desirable to prevent heat from the hot-filament 30 reaching the imprint template 20. FIG. 4 depicts an apparatus which can be used to clean the imprint template 20 of imprint medium 21, while reducing the heating of the imprint template 20. FIG. 4 depicts a chamber 40. Located in the chamber is a hot-filament 41. The chamber 40 is provided with an outlet port 42. The outlet port 42 leads into a tube 43 which is arranged to extend toward and open adjacent to a surface of the imprint template 20 to be cleaned of contamination 21. The imprint template 20 is shielded from the heat generated by the hot-filament 41 by a heat shield 44. The tube 43 extends through the heat shield 44.

The heat shield 44 may be formed from any suitable material, and in particular any material which is known to absorb or reflect heat. For example, the heat shield 44 may be formed from a ceramic material or metal, and/or or may be formed with a reflective surface. The heat shield 44 may also be cooled using a fluid flowing alongside or in the heat shield 44, or in a conduit in contact with the heat shield 44.

In use, hydrogen 45 is passed over the hot-filament 41, which causes the hydrogen 45 to disassociate into atomic hydrogen radicals 46. The atomic hydrogen radicals travel along the tube 43 and onto the surface of the imprint template 20 to be cleaned. The imprint template 20 is then cleaned as described above.

The tube 42 which transports the hydrogen radicals 46 to the imprint template 20 desirably has a low surface recombination coefficient for hydrogen radicals (or whichever reductive fluid is used to clean the imprint template 20). Quartz, borosilicate glass (for example, Pyrex™), fused silica and glass are suitable materials for transporting the hydrogen radicals 46, since the surface recombination coefficient of these materials for hydrogen radicals is low (for example 4×10⁻³ to 7×10⁻⁴) when compared to, for example, platinum (which has a recombination coefficient for hydrogen radicals of 1). Similarly, if a chamber or any other device is arranged to, in use, expose the imprint template to hydrogen radicals (or any other reductive fluid), the device should have a low surface recombination coefficient with respect to the reductive fluid used. For example, the device may be formed from quartz, borosilicate glass (for example, Pyrex™), fused silica or glass.

It is desirable to clean the imprint template as quickly as possible, and it is therefore desirable that the speed at which the reductive fluid (e.g. hydrogen radicals) reacts with or etches the imprint medium is also as high as possible. The reaction of hydrogen radicals with the imprint medium (for example, resist) is generally an exothermic reaction. That is, heat is liberated during the reaction. Thus, higher reaction speed results in increased heating of the imprint template. The heating of the template can be a limiting factor in the cleaning process when the imprint template has reached the maximum allowable temperature (which corresponds to the pattern on the imprint template becoming too distorted for immediate use, and may be around, for example, 50° C.). FIGS. 5a and 5b depict apparatuses which may be used to reduce or prevent excessive heating of the imprint template 20, and/or an imprint template holder 50 which is used to hold the imprint template 20. To reduce or prevent excessive heating of the imprint template 20, the imprint template 20, and/or imprint template holder 50 can be actively conditioned, e.g. cooled. Active cooling can be achieved by passing a fluid 60 via a conduit 61 which is in contact with or in close proximity to the imprint template 20 and/or the imprint template holder 50. Heat from the imprint template 20 and/or the imprint template holder 50 is dissipated into the conduit 61 and the fluid 60 which is passing through it. This dissipated heat heats up the fluid 60. The fluid 60 flows through the conduit 61, and thus takes heat which it contains away from the imprint template 20 and/or the imprint template holder 50. The fluid 60 maybe, for example, water.

It is desirable that reaction products which are formed in the cleaning of the imprint template are removed as quickly as possible from the vicinity of the imprint template. This is because it is desirable to reduce or eliminate the probability of these reaction products being deposited elsewhere on the imprint template, or elsewhere in and around the apparatus used to clean the imprint template. The reaction products may therefore be removed using an exhaust, or other pumping or extraction apparatus. The reactions products could then be vented to atmosphere, or to a scrubbing apparatus, for example.

It is known that hydrogen radicals formed near the hot-filament are not stable and may eventually recombine to form molecular hydrogen. It is therefore advantageous to reduce the time between radical formation and reaction with the imprint medium on the imprint template, since this will lead to a higher hydrogen radical concentration on the surface of the imprint template. Reduction in the time between radical formation and contact with the imprint template can be achieved by using a carrier gas. Desirably, the carrier gas is an inert gas, and this inert gas may be used to transport the hydrogen radicals to the imprint template after they have been formed at or in the vicinity of the hot-filament. A suitable carrier gas is, for example, Ar, He, Ne, Xe, Kr, and/or Rn.

In the above embodiment, a heat shield and active cooling have been described as being suitable to reduce the heating of the imprint template. These solutions can be replaced or supplemented by using a pulsed cleaning scheme. For example, rather than allowing the hot-filament to continuously emit heat, the hot-filament may be repeatedly turned on and off to allow the imprint template to cool down when the hot-filament is not emitting heat. For example, the hot-filament may be turned on for 10 seconds, and then turned off for 10 seconds in a repetitious pulsed manner. This process may be repeated until the imprint template is clean of imprint medium.

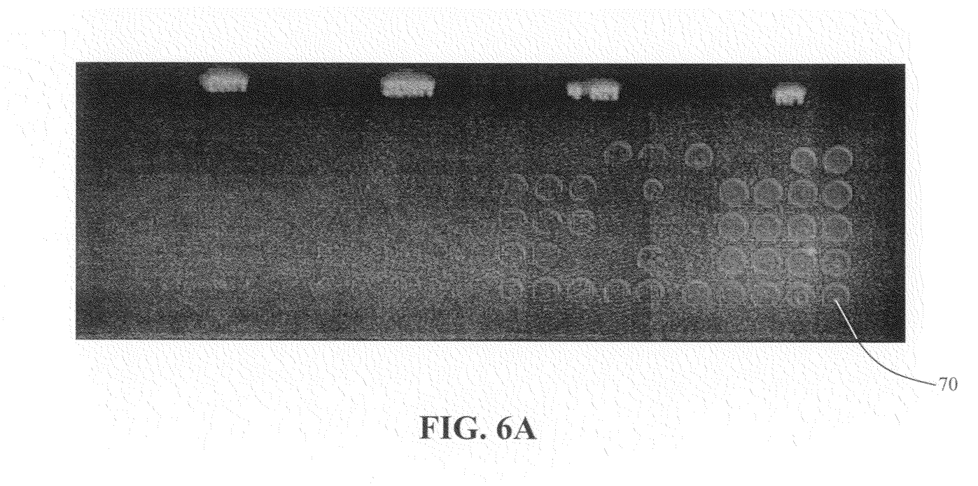

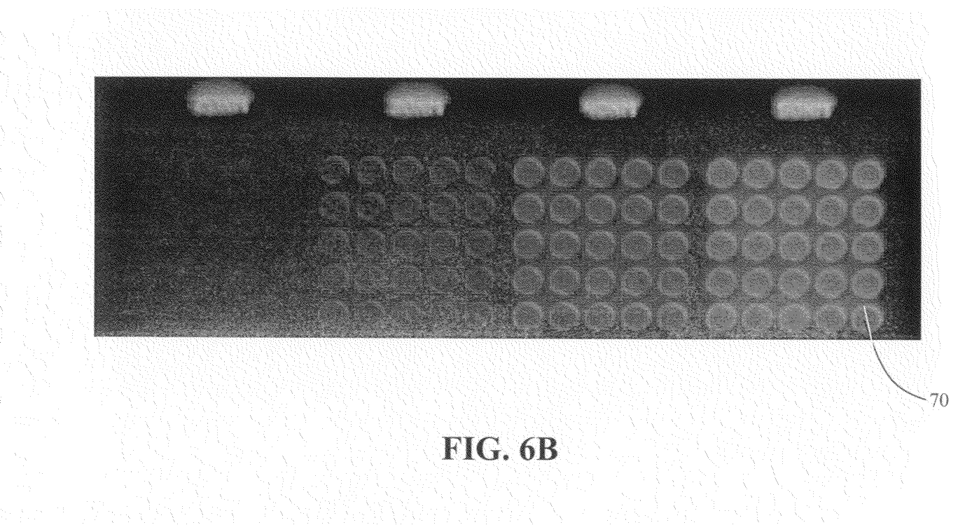

FIGS. 6a and 6b illustrate examples of the possible effectiveness of the cleaning methods described above. FIGS. 6a and 6b depict dark field microscope images of (part of) an imprint template with four fields of pattern features 70 increasing in size from left to right. FIG. 6a shows the pattern features after the imprint template has been used to imprint a number of patterns. During the imprints, material (e.g. resist) becomes stuck to the imprint template, and it can be seen that some of the patterns feature 70 have at least partially disappeared in the dark field microscope image. In other words, the material which has stuck in-between and onto the features 70 have resulted in a loss of optical contrast in the microscope image. The imprint template is then cleaned using a reductive fluid (e.g. hydrogen radicals) as described above. FIG. 6b shows that the pattern features 70 are now clearly visible, and are defect free. This shows that the cleaning step was successful in removing resist from the pattern features 70.

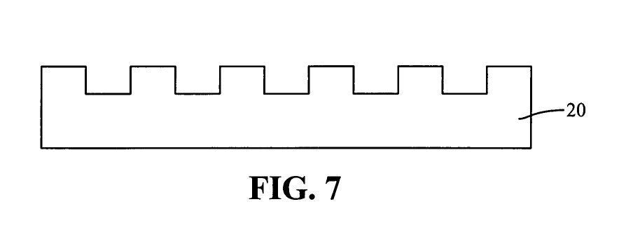

FIG. 7 schematically depicts an imprint template 20 which has been cleaned using the methods and apparatuses described above. It can be seen that, after the cleaning process, there is substantially no imprint medium remaining on the imprint template.

Instead of using a hydrogen gas to generate the hydrogen radicals, a hydrogen halide gas may be used. An advantage of using a halide gas is that halogens may be used to remove materials that cannot be removed (either at all, or as easily) using hydrogen radicals alone. Alternatively or additionally, a metal material serving as a catalyst for hydrogen radical formulation may be provided in the vicinity of the hot-filament, or may form at least a part of the hot-filament. The metal catalyst may be selected from the group consisting of Ti, Pt, Ni, V, Mg, Mn, Ru, W, and Ta (and alloys and combinations thereof).

The cleaning apparatus as described above may be housed in a cleaning chamber. Alternatively, the cleaning apparatuses described above may be part of another system, for example, an imprint lithography system or the like. That is, the imprint template may be cleaned in-situ or ex-situ of the imprint lithography system.

The imprint template may be cleaned at specific times, for example after a batch of patterns has been imprinted on a substrate. Alternatively or additionally, the imprint template could be periodically tested to determine whether it has too much contamination (e.g. imprint medium) attached to it, and the imprint template could then be cleaned if it is too contaminated.

In the above embodiments, the cleaning of an imprint template has been described. However, in an embodiment, the methods described above may be used to clean other objects and/or surfaces of those objects. For example, in an embodiment, the embodiments described above may be used to clean the patterned surfaces of objects having or being formed from glass, fused silica, or quartz. The use of reductive fluid to clean such patterned surfaces is a quick cleaning solution, as described above. Examples of patterned surfaces may include the burled surface of a substrate table or carrier, e.g. a wafer or reticle table/carrier, or gratings, e.g. diffraction gratings for use in lithography, etc.

As mentioned above, the reductive fluid used to clean the imprint template does not need to be or comprise hydrogen or deuterium radicals. Other reductive fluids may be used.

It will be appreciated that the above embodiments have been described by way of example only. It can be appreciated by one of ordinary skill in the art that various modifications may be made to these and other embodiments without departing from the invention as defined by the claims that follow.

What is claimed is:

1. A method of cleaning an imprint template, comprising:
exposing the imprint template to a reductive fluid.

2. The method of claim 1, wherein the fluid is a gas.

3. The method of claim 1, wherein the fluid comprises hydrogen or deuterium radicals.

4. The method of claim 1, wherein the reductive fluid is generated from another fluid.

5. The method of claim 4, wherein a microwave or radio wave discharge is introduced in the another fluid to at least partially generate the reductive fluid.

6. The method of claim 4, wherein the another fluid is passed over a heat source to at least partially generate the reductive fluid.

7. The method of claim 4, wherein the another fluid is hydrogen gas or deuterium gas.

8. The method of claim 4, wherein the another fluid is hydrogen halide gas or deuterium halide gas.

9. The method of claim 6, wherein the heat source is a hot-filament.

10. The method of claim 6, wherein the heat source is used in conjunction with a catalyst to promote generation of the reductive fluid.

11. The method of claim 10, wherein the catalyst is a metal.

12. The method of claim 11, wherein the metal is one of: Ti, Pt, Ni, V, Mg, Mn, W, Ru, Ta and an alloy or other combination of one or more of the foregoing.

13. The method of claim 11, wherein the metal is an alloy comprising one or more of: Ti, Pt, Ni, V, Mg, Mn, W, Ru, and Ta.

14. The method of claim 6, wherein the heat source is pulsed.

15. The method of claim 6, wherein a heat shield is used to shield the imprint template from the heat source.

16. The method of claim 6, wherein the imprint template is cooled by passing a fluid through a conduit which is in contact with or adjacent to the imprint template.

17. The method of claim 6, wherein the imprint template is cooled by passing a fluid through a conduit which is in contact with or adjacent to an imprint template holder which holds the imprint template.

18. The method of claim 1, wherein the reductive fluid is carried by a carrier fluid.

19. The method of claim 18, wherein the carrier fluid is a carrier gas.

20. The method of claim 1, wherein a device is used to expose the imprint template to the reductive fluid.

21. The method of claim 20, wherein the device is a chamber which contains the reductive fluid, the imprint template being locatable in the chamber.

22. The method of claim 20, wherein the device is a conduit.

23. The method of claim 22, wherein the conduit is a tube.

24. The method of claim 20, wherein a surface of the device comprises a material having a low surface recombination coefficient with respect to the reductive fluid used.

25. The method of claim 20, wherein the device is at least partially formed from quartz, borosilicate glass, fused silica or glass.

26. The method of claim 1, wherein the imprint template is at least partially formed from glass, fused silica or quartz.

27. An imprint template cleaning apparatus, comprising:
a device which, in use, is arranged to expose an imprint template to a reductive fluid.

28. The apparatus of claim 27, wherein the device is a chamber which is arranged to contain the reductive fluid, the imprint template being locatable in the chamber.

29. A method of cleaning a patterned surface, the patterned surface comprising one of glass, quartz or fused silica, the method comprising:
exposing the patterned surface to a reductive fluid.

30. The method of claim 29, wherein the patterned surface is at least a part of an imprint template.

31. A patterned surface cleaning apparatus comprising:
a device which, in use, is arranged to expose a patterned surface to a reductive fluid, wherein the patterned surface comprises one of glass, quartz or fused silica.
